(19) United States
(12) Patent Application Publication
(10) Pub. No.: US 2008/0261512 A1
(43) Pub. Date: Oct. 23, 2008

(54) SYSTEMS AND METHODS FOR SATELLITE AUGMENTED WIRELESS COMMUNICATION NETWORKS

(75) Inventors: Celite Milbrandt, Austin, TX (US); Safdar Mahmood Asghar, Austin, TX (US)

Correspondence Address: COOLEY GODWARD KRONISH LLP;ATTN: Patent Group, Suite 1100, 777 - 6th Street, NW, WASHINGTON, DC, 20001, US

(73) Assignee: SLACKER, INC., San Diego, CA (US)

(21) Appl. No.: 12/032,637

(22) Filed: Feb. 15, 2008

Related U.S. Application Data
(60) Provisional application No. 60/890,164, filed on Feb. 15, 2007.

(51) Int. Cl. H04H 20/74

(52) U.S. Cl. 455/3.02

(57) ABSTRACT

A system and method for a satellite augmented wireless communication network is disclosed. The method includes transmitting at least a portion of digital data via a satellite communication network to a satellite signal receiving device, receiving the digital data by the satellite signal receiving device, and providing the received digital data to a wireless communication device, wherein the wireless communication device is operable in a wireless communication network and is communicatively coupled to the satellite receiving device. The system includes a wireless communication device operative in a wireless communication network comprising a plurality of terrestrial receivers and terrestrial transmitters, each serving a designated service region, and a satellite signal receiving device operative in a satellite communication network comprising a plurality of satellite and satellite transponders, wherein the satellite receiver is communicatively coupled with the wireless communication device.

### RELATED APPLICATIONS

This application claims priority under 35 U.S.C. § 119(e) to U.S. Provisional Patent Application Ser. No. 60/890,164, entitled SYSTEMS AND METHODS FOR SATELLITE AUGMENTED WIRELESS COMMUNICATION NETWORKS, filed Feb. 15, 2007, the content of which is hereby incorporated by reference herein in its entirety for all purposes.

This application is related to U.S. Utility patent application Ser. No. 11/955,299, entitled METHOD AND APPARATUS FOR INTERACTIVE DISTRIBUTION OF DIGITAL CONTENT, filed on Dec. 12, 2007, to U.S. Utility patent application Ser. No. 11/923,573, entitled METHODS AND SYSTEMS FOR PERSONALIZED RENDERING OF DIGITAL MEDIA CONTENT, filed on Oct. 24, 2007, to U.S. Utility patent application Ser. No. 11/923,554, entitled SYSTEMS AND DEVICES FOR PERSONALIZED RENDERING OF DIGITAL MEDIA CONTENT, filed on Oct. 24, 2007, to U.S. Utility patent application Ser. No. 11/637,300, entitled METHOD AND APPARATUS FOR INTERACTIVE DISTRIBUTION OF DIGITAL CONTENT, filed on Dec. 12, 2006, and to U.S. Provisional Patent Application Ser. No. 60/862,736, entitled METHOD AND DEVICE FOR PLAYBACK OF LOCALLY STORED DIGITAL MEDIA CONTENT, filed Oct. 24, 2006. The contents of each of these applications is hereby incorporated by reference herein in its entirety for all purposes.

### FIELD OF THE INVENTION

The present invention relates generally to wireless communication networks augmented by satellite communication networks. More particularly, the invention relates to systems and methods for increasing the network capacity of a communication system including a terrestrial wireless communication network by augmenting the system with a satellite communication network.

### BACKGROUND

Bandwidth is a precious commodity in communication networks and the need for it is constantly increasing. Users continue to demand additional bandwidth for transmitting and receiving increasing amounts of information to wireless devices in shorter amounts of time. During peak bandwidth utilization periods, a significant amount of bandwidth is needed to download multimedia content, which greatly limits the speed and availability of the delivery of this content. In response to this incessant demand for bandwidth, providers continue to look for ways to easily, effectively, and affordably increase bandwidth in existing wireless communication networks. Consequently, new approaches are needed that provide high bandwidth data transmission at reasonable cost by using, to the greatest extent possible, existing communication infrastructures.

### SUMMARY

In general, one or more embodiments of the present invention utilize a satellite communication network to augment the capacity of a terrestrial wireless communications network. In typical embodiments, aspects of the present invention may aid in facilitating transmission of digital data, such as digital media content, to one or more wireless enabled devices.

In one embodiment, a method of the invention comprises transmitting at least a portion of digital data via a satellite communication network to a satellite, receiving the digital data at the satellite, and providing the received digital data to a wireless communication device, wherein the wireless communication device is configured to be operable in a terrestrial wireless communication network and is communicatively coupled to the satellite receiving device. The wireless communications device may further be configured to selectively process and store, based on a user provided selection criteria, at least a part of the received digital data.

In one embodiment, systems may include wireless communication devices, terrestrial transmitters, and satellite systems working in combination to augment the capacity of a terrestrial wireless network. Wireless communication devices may operate in a wireless communication network comprising one or more terrestrial receivers and terrestrial transmitters, each serving a service area or region. Satellite signal receiving devices may operate in a satellite communication network comprising one or more satellites and satellite transponders. The satellite receivers may be communicatively coupled with the wireless communication devices to increase overall system throughput.

In some embodiments, satellite communication networks can be used to augment existing wireless communication networks in a variety of ways, such as by transmitting data that demands a high amount of bandwidth for transmission, transmitting data during times of high bandwidth utilization when traffic loading exceeds current throughput capacity and/or transmitting data during times when terrestrial wireless communication networks are inoperable. Since most traffic in a typical system will be asymmetric, utilizing a satellite downlink stream to augment a system including a terrestrial wireless bi-directional communication network may ease the overall burden on the bandwidth of the existing terrestrial wireless communication network, thus allowing the network to remain open for direct interactive communication, such as for traditional terrestrial communications such as voice or data communication.

In one embodiment, a user can request data from a wireless communication network through the wireless device, wherein a control unit communicatively coupled with the wireless communication network can determine if the data requested demands a high amount of bandwidth. If so, some or all of the data requested can be transmitted to the user's wireless device via a satellite communication network rather than via a terrestrial wireless communication network.

In one embodiment, a user can request data from a wireless communication network, wherein a control unit communicatively coupled with the wireless communication network determines if the transmission requirement of the data exceeds the transmission capacity of the network. Some or all of the data can then be transmitted to the user via a satellite communication network, resulting in a potential decrease in the overall burden of high bandwidth transmission on the terrestrial wireless communication network.

In one embodiment, a wireless device communicatively coupled with a satellite receiver can operate to receive data without the user requesting such data.

Embodiments may be configured to allow a wireless communication device to bypass its traditional terrestrial wireless communication network in whole or in part as necessary in order to continue to receive data. A terrestrial uplink station can transmit data via a satellite to the wireless communication device communicatively coupled to a satellite receiver without the need for a terrestrial transmitter. Consequently, the traditional terrestrial wireless communication network can be bypassed in whole or in part. As an example, in emergency situations when terrestrial wireless communication networks are down, emergency information can still be received by a wireless communication device via a satellite and a satellite receiver.

In one embodiment, continuously streaming media can be transmitted via a satellite communication network to a wireless communication device, wherein the device can buffer the multi-media content during off peak bandwidth utilization periods, as determined by the control unit, for use during peak periods. For example, instead of downloading digital data in the form of songs (audio files) through a terrestrial wireless communication network to a portable wireless device during peak times, music continuously streaming from a satellite, such as by satellite radio, can be buffered by a satellite receiver and/or wireless communication device and can be utilized later by the user as he or she desires. Content can be stored on the wireless device, and the storage can further be based on a user provided content selection criteria.

Additional aspects of the present invention are further described and illustrated in the detailed description and drawings.

### BRIEF DESCRIPTION OF THE DRAWINGS

The invention is more fully appreciated in connection with the following detailed description taken in conjunction with the accompanying drawings, wherein:

FIG. 1a illustrates the general system architecture of a prior art terrestrial wireless communications network.

FIG. 1b illustrates the general system architecture of a satellite augmented wireless communication network in accordance with one embodiment of the present invention.

FIG. 2 illustrates a satellite receiving apparatus communicatively coupled with a wireless communication device in accordance with one embodiment of the present invention.

FIG. 3 is a flowchart depicting one method of utilizing satellites to augment a wireless communication network in accordance with one embodiment of the present invention.

FIG. 4 is a flowchart depicting one method of utilizing satellites to augment a wireless communication network in accordance with one embodiment of the present invention.

FIG. 5 is a flowchart depicting one method of providing digital data to a wireless device using satellite augmentation of a terrestrial wireless communication network in accordance with aspects of the present invention.

FIG. 6 is an illustration of one embodiment of an embedded processor system for facilitating implementation of aspects of the present invention on a wireless device.

FIG. 7 is an illustration of one embodiment of a processor system for facilitating implementation of aspects of the present invention in a control unit.

### DETAILED DESCRIPTION

This application is related to U.S. Utility patent application Ser. No. 11/955,299, entitled METHOD AND APPARATUS FOR INTERACTIVE DISTRIBUTION OF DIGITAL CONTENT, to U.S. Utility patent application Ser. No. 11/923,573, entitled METHODS AND SYSTEMS FOR PERSONALIZED RENDERING OF DIGITAL MEDIA CONTENT, to U.S. Utility patent application Ser. No. 11/923,554, entitled SYSTEMS AND DEVICES FOR PERSONALIZED RENDERING OF DIGITAL MEDIA CONTENT, to U.S. Utility patent application Ser. No. 11/637,300, entitled METHOD AND APPARATUS FOR INTERACTIVE DISTRIBUTION OF DIGITAL CONTENT and to U.S. Provisional Patent Application Ser. No. 60/862,736, entitled METHOD AND DEVICE FOR PLAYBACK OF LOCALLY STORED DIGITAL MEDIA CONTENT. The contents of each of these applications is hereby incorporated by reference herein in its entirety for all purposes. These applications may also be denoted collectively herein as the “related applications” for purposes of brevity.

In the following description reference is made to the accompanying drawings wherein are shown, by way of illustration, several embodiments of the present invention. It is understood by those of ordinary skill in the art that other embodiments may be utilized and structural changes made without departing from the spirit and scope of the present invention.

In general, one or more embodiments of the present invention utilize a satellite communication network to augment the capacity of a terrestrial wireless communications network. In typical embodiments, aspects of the present invention may aid in facilitating transmission of digital data, such as digital media content, to one or more wireless enabled devices.

In one embodiment, a method of the invention comprises transmitting at least a portion of digital data via a satellite communication network to a satellite, receiving the digital data at the satellite, and providing the received digital data to a wireless communication device, wherein the wireless communication device is configured to be operable in a terrestrial wireless communication network and is communicatively coupled to the satellite receiving device. The wireless communications device may further be configured to selectively process and store, based on a user provided selection criteria, at least a part of the received digital data.

In one embodiment, systems may include wireless communication devices, terrestrial transmitters, and satellite systems working in combination to augment the capacity of a terrestrial wireless network. Wireless communication devices may operate in a wireless communication network comprising one or more terrestrial receivers and terrestrial transmitters, each serving a service area or region. Satellite signal receiving devices may operate in a satellite communication network comprising one or more satellites and satellite transponders. The satellite receivers may be communicatively coupled with the wireless communication devices to increase overall system throughput.

In some embodiments, satellite communication networks can be used to augment existing wireless communication networks in a variety of ways, such as by transmitting data that demands a high amount of bandwidth for transmission, transmitting data during times of high bandwidth utilization when traffic loading exceeds current throughput capacity and/or transmitting data during times when terrestrial wireless communication networks are inoperable. Since most traffic in a typical system will be asymmetric, utilizing a satellite downlink stream to augment a system including a terrestrial wireless bi-directional communication network may ease the overall burden on the bandwidth of the existing terrestrial wireless communication network, thus allowing the network to remain open for direct interactive communication, such as for traditional terrestrial communications such as voice or data communication.

In one embodiment, a user can request data from a wireless communication network through the wireless device, wherein a control unit communicatively coupled with the wireless communication network can determine if the data requested demands a high amount of bandwidth. If so, some or all of the data requested can be transmitted to the user's wireless device via a satellite communication network rather than via a terrestrial wireless communication network.

In one embodiment, a user can request data from a wireless communication network, wherein a control unit communicatively coupled with the wireless communication network determines if the transmission requirement of the data exceeds the transmission capacity of the network. Some or all of the data can then be transmitted to the user via a satellite communication network, resulting in a potential decrease in the overall burden of high bandwidth transmission on the terrestrial wireless communication network.

In one embodiment, a wireless device communicatively coupled with a satellite receiver can operate to receive data without the user requesting such data.

Embodiments may be configured to allow a wireless communication device to bypass its traditional terrestrial wireless communication network in whole or in part as necessary in order to continue to receive data. A terrestrial uplink station can transmit data via a satellite to the wireless communication device communicatively coupled to a satellite receiver without the need for a terrestrial transmitter. Consequently, the traditional terrestrial wireless communication network can be bypassed in whole or in part. As an example, in emergency situations when terrestrial wireless communication networks are down, emergency information can still be received by a wireless communication device via a satellite and a satellite receiver.

In one embodiment, continuously streaming media can be transmitted via a satellite communication network to a wireless communication device, wherein the device can buffer the multi-media content during off peak bandwidth utilization periods, as determined by the control unit, for use during peak periods. For example, instead of downloading digital data in the form of songs (audio files) through a terrestrial wireless communication network to a portable wireless device during peak times, music continuously streaming from a satellite, such as by satellite radio, can be buffered by a satellite receiver and/or wireless communication device and can be utilized later by the user as he or she desires. Content can be stored on the wireless device, and the storage can further be based on a user provided content selection criteria.

Additional aspects of the present invention are described below.

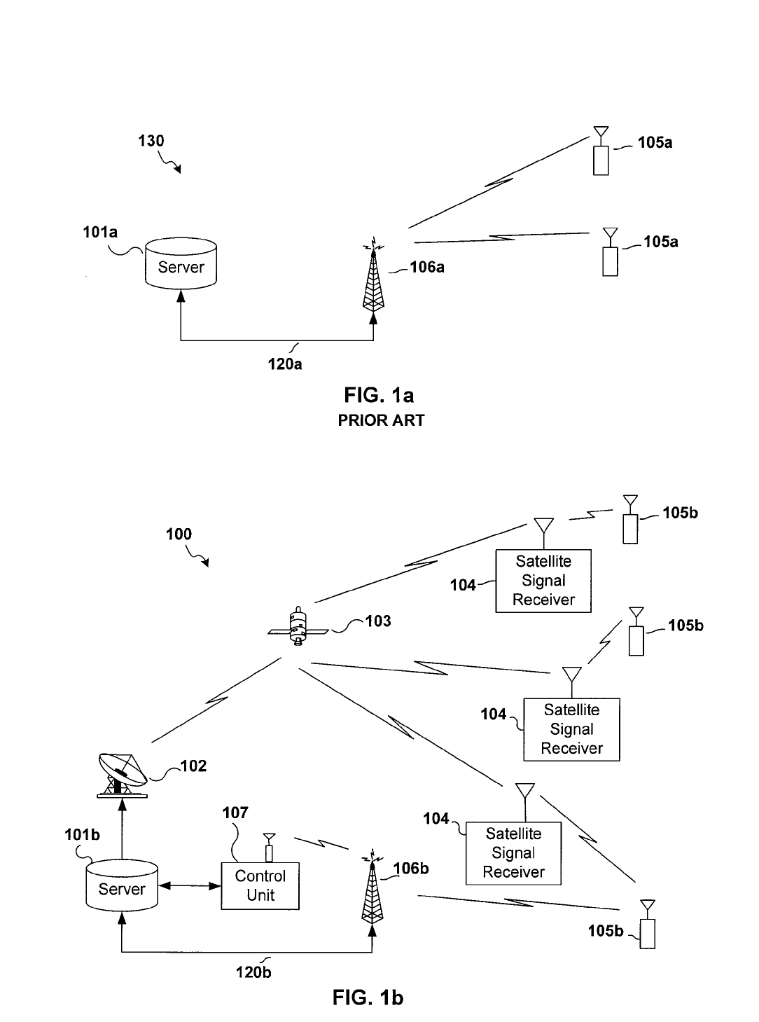

Turning now to the drawings, FIG. 1a illustrates a prior art terrestrial communication network 130 configured for data transmission. The network includes a server 101a containing data to be transmitted, a transmission line 120a, a terrestrial transmission tower 106a including a transmitter, and one or more wireless communications devices 105a for receiving transmitted data. Data transmission begins at server 101a where the data is sent to terrestrial transmission tower 106a via a wired connection, such as transmission line 120a. After reaching transmission tower 106a, the data is transmitted terrestrially to one or more wireless communications devices 105a within reception range of transmission tower 106a.

FIG. 1b illustrates an embodiment of a satellite augmented wireless communication network 100 according to aspects of the present invention. As with system 130 shown in FIG. 1a, wireless communication network 100 may include a server element 101b containing data to be transmitted to wireless communication devices 105b. Data may include a variety of digital data types and formats such as binary data, text, images, audio files such as MP3, WAV, AAC or other standard or proprietary digital audio formats, video files or other types of digital data. The digital data may further include metadata associated with the digital data, such as is described in the related applications and in particular in U.S. Utility patent application Ser. No. 11/955,299 entitled METHOD AND APPARATUS FOR INTERACTIVE DISTRIBUTION OF DIGITAL CONTENT and U.S. Utility patent application Ser. No. 11/923,554 entitled SYSTEMS AND DEVICES FOR PERSONALIZED RENDERING OF DIGITAL MEDIA CONTENT, the contents of which are incorporated by reference herein. Server element 101b may also include or be coupled with other systems such as computer systems, databases and the like configured to select and provide content to be sent to devices 105b, such as are described in the related applications. Transmission to wireless communication devices 105b may be done in a variety of ways, including by sending part or all of the data via terrestrial transmission as shown in FIG. 1a.

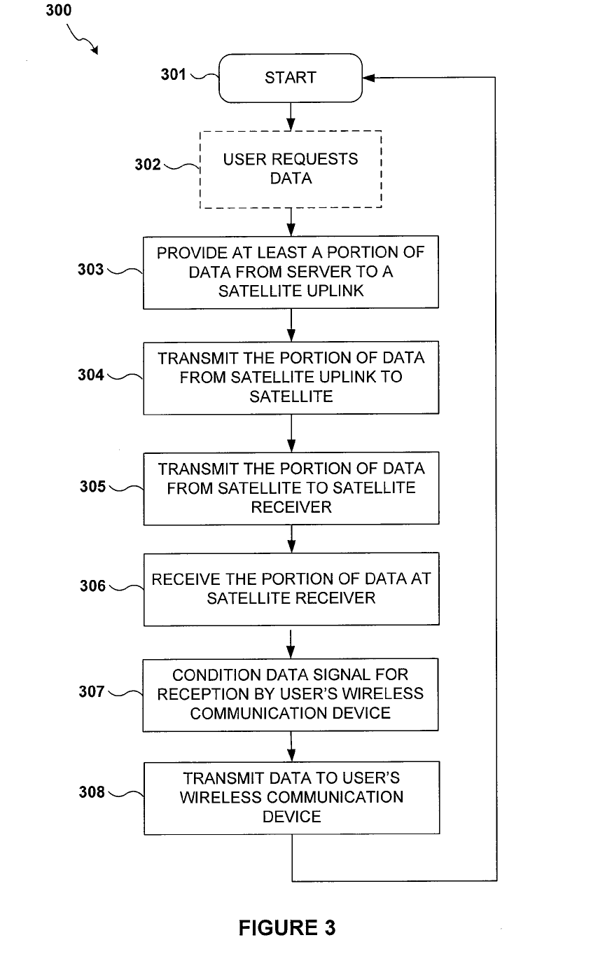

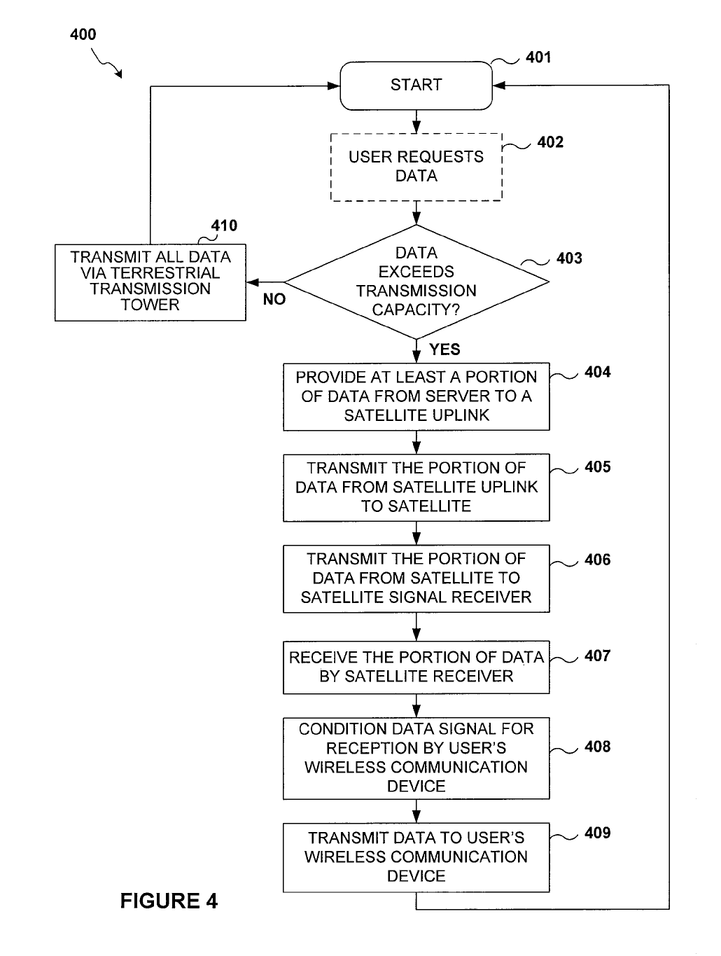

However, in some embodiments, aspects of the present invention expand on the system shown in FIG. 1a by implementing and controlling additional transmission paths as described herein. For example, depending on which embodiment is used, such as is further detailed in the embodiments shown in FIGS. 3 and 4, all the data may be sent over a satellite transmission. Alternately, data transmission may be allocated between satellite transmission and conventional terrestrial transmission via transmission tower 106b. The division of data may be accomplished by a control unit 107 that may be connected to a wireless network for monitoring, control, data division, data processing or other associated or related purposes. Data may be allocated between satellite transmission and conventional terrestrial transmission in a variety of ways. For example, allocation strategies can be based on data transmission requirements, transmission costs, throughput parameters, or other system characteristics and/or parameters.

In some embodiments, data selected for satellite transmission by control unit 107 and/or systems included in or coupled to server 101b may be sent to a satellite 103 from a server, such as server 101b, via a satellite uplink device 102. The satellite 103 can be a low orbit, medium orbit or geosynchronous orbit satellite used to provide broadband data to users via satellite signal receiver 104. In one exemplary embodiment, satellite 103 includes a plurality of transponders, each of which can be used to relay data from uplink 102 to the user.

In typical embodiments, satellite signal receiver 104 is a small portable device or module, with a small antenna. In some embodiments the satellite signal receiver may be located in a motor vehicle in close proximity with a wireless communication device such as wireless communication device 105b. In some embodiments, the satellite signal receiver 104 and portable device 105b may be a single device or provided in a single package or as a single component.

Depending on which embodiment is employed, as, for example, is shown in representative embodiments as described in further detail with respect to FIGS. 3 and 4, implementations of the present invention may be configured to allow a user to request data from a wireless communication device 105b by explicitly sending a request for data. For example, in one embodiment a user may send a request to a terrestrial transmission tower 106b, which then forwards the request to a server 101b. In some embodiments this user request may be done via a wireless local area network (WLAN) or wide area network, such as a Wi-Fi or Wi-Max network. Alternatively, the wireless communication network 100 may be continuously sending data to users. In either implementation, satellite signal receiver 104 may receive, condition and retransmit a satellite signal to a wireless communication device 105b.

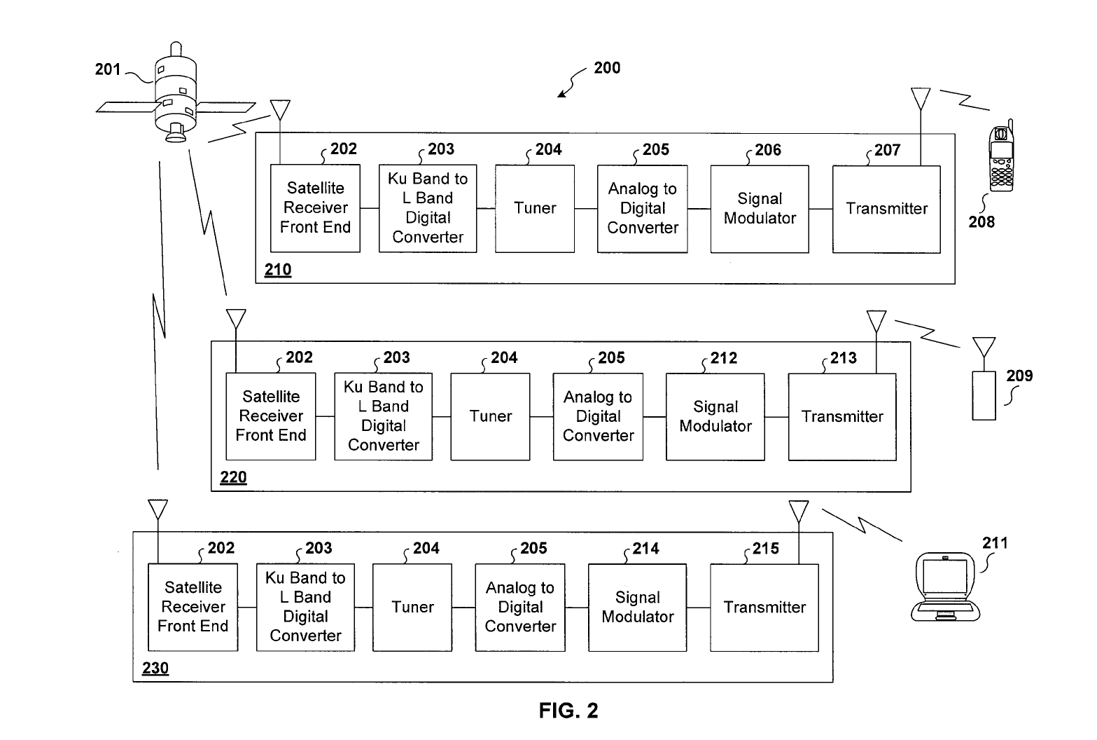

FIG. 2 is a block diagram of embodiments of satellite signal receivers 210, 220 and 230 in accordance with certain aspects of the present invention. In an exemplary system embodiment, satellite 201 includes a plurality of transponders, each of which can be used to relay data to a plurality of satellite signal receivers such as receivers 210, 220 and 230. Receivers 210, 220 and 230 may be configured to operate with a common satellite front end but with different output functionality as is further described below. For example, a satellite receiver front end 202 receives and outputs a satellite signal transmitted by satellite 201. The output signal is then directed to a modulator such as modulator 206, 212 and 214. In one embodiment this may be done by directing the signal to a frequency converter 203 where the signal is converted from a received frequency band to another frequency band for processing. In a typical embodiment the signal is downconverted from the Ku band to the L band. However, other band conversions may be employed based on system and implementation requirements. The signal is then provided to a tuner 204 where a content signal is extracted from the modulated carrier signal. The tuner output signal may be a baseband signal which is then provided to an analog-to-digital converter 205. Analog-to-digital converter 205 may then convert the baseband analog signal into digital data.

The digital data signal may then be provided to a modulator such as modulator 206, 212 and 214. Typically the modulator will be configured to operate using a particular band and modulation scheme based on the targeted end user device. For example, the modulator may modulate the digital data to be compatible with a wireless communication device, such as a cell phone 208, Bluetooth enabled wireless device 209, or wireless networking enabled computer 211. Associated transmitter elements, such as transmitter 207, 212 and 213, may then transmit the modulated data signal for reception by the wireless communication device, such as wireless devices 208, 209 and 211. Exemplary wireless communications devices may include Bluetooth enabled devices based on the Bluetooth wireless networking standard, Wi-Fi devices such as those based on the IEEE 802.11 wireless local area network standard, devices based on other wireless networking standards, and/or cellular phones. In some embodiments, satellite signal receivers such as receiver 210 may be configured to use one antenna to both receive and transmit signals. While typical embodiments employ a wireless connection to the portable device, such as devices 208, 209 and 210 as shown in FIG. 2, in some embodiments a wired connection (not shown) to the portable device may be used in place of, or in addition to, the wireless connection. For example, such connections may be implemented with Serial or parallel connections, Ethernet, USD, Firewire or other wired connection methods.

FIG. 3 is a flow chart illustrating one embodiment of a process 300 for implementing certain aspects of the present invention related to providing data to a user. Process 300 may begin with a “start” step 301. Initiation of the data transfer process may be either automatic, without user input, or may begin with the user requesting data, e.g., as shown in optional step 302. At step 303, at least a portion of the digital data is provided to a satellite uplink such as satellite uplink 102 as shown in FIG. 1b. Selection of the portional data may be performed by control unit 107 based on a variety of criteria including terrestrial wireless network capacity, data size, cost or other data partitioning criteria.

The selected portional data is then transmitted to a satellite, such as satellite 201 as shown in FIG. 2, in step 304, and then to a satellite signal receiver, such as satellite signal receiver 210 as shown in FIG. 2, in step 305. The data is then received by the satellite signal receiver as shown in step 306, where the signal may be conditioned so that a wireless communication device, such as wireless communication device 105b as shown in FIG. 1b, can receive it as shown in step 307. The data is then transmitted to the wireless communication device as shown in step 308. After completion of step 308 the process may optionally return to the start step 301 and repeat.

FIG. 4 is a flow chart illustrating one embodiment of a process 400 for implementing certain aspects of the present invention related to providing data to a user where data requirements exceed terrestrial transmission capacity. Process 400 may begin with a “start” step 401. Data to be provided to a user from a server, such as server 101b as shown in FIG. 1b, can either be requested by a user or simply transmitted, without user input, as shown in optional step 402. Next, the data is examined to determine if the transmission requirements of the data exceed the transmission capacity of a convention terrestrial transmission tower, such as transmission tower 106b as shown in FIG. 1b, in decision step 403. This process may occur in and/or be managed by a control unit, such as control unit 107 as shown in FIG. 1. If the transmission requirement does not exceed the transmission capacity, all of the data may be transmitted by the terrestrial transmission tower as shown in step 410. However, if the transmission requirements of the data exceed the terrestrial transmission capacity, at least a portion of the data (denoted herein as portional data) contained in or provided by the server 101b may then be provided to a satellite uplink, such as satellite uplink 102 as shown in FIG. 1, as shown in step 404. The portional data is then transmitted to a satellite, such as satellite 201 as shown in FIG. 2, in step 405, and then to a satellite signal receiver, such as satellite signal receiver 210 as shown in FIG. 2, in step 406. The data is then received by the satellite signal receiver, as shown in step 407, where the signal may be conditioned so that a wireless communication device, such as wireless communication device 105 as shown in FIG. 1, can receive it as shown in step 408. The data may then be transmitted to the wireless communication device as shown in step 409. After completion of step 409, the process may optionally return to the start step 401 and repeat.

Portional data selection as provided by or facilitated in conjunction with server 101b and/or control unit 107 may be based on a variety of selection criteria. For example, selection may be based on determining if a transmission requirement of the digital data exceeds a capacity of the terrestrial wireless network the user's wireless device is operating in. Responsive to this determination, data may be selected for transmission via satellite 103 to one or more devices 105b. In one embodiment the transmission requirement is a minimum bandwidth required for data transmission and the capacity is a maximum terrestrial wireless network bandwidth. In another embodiment, the transmission requirement is a size metric of the digital data and the capacity is a maximum data size of the terrestrial wireless network. In another embodiment the transmission requirement is a set of cost of service parameters and the capacity is a maximum cost associated with the terrestrial wireless network. In yet another embodiment the transmission requirement is a throughput parameter and the capacity is a maximum throughput. It is apparent that other selection criteria could also be applied in keeping within the spirit and scope of the present invention.

In either embodiment as illustrated in FIGS. 3 and 4, as well as in other embodiments, content received at the portable device, such as devices 105b, 208, 209 or 211, may be further processed based on user specific criteria to be selectively stored and/or selectively rendered on the device. Aspects of such storage and rendering processes are further described and illustrated in the related applications, and in particular in U.S. Utility patent application Ser. No. 11/923,554, entitled SYSTEMS AND DEVICES FOR PERSONALIZED RENDERING OF DIGITAL MEDIA CONTENT, incorporated by reference herein in its entirety.

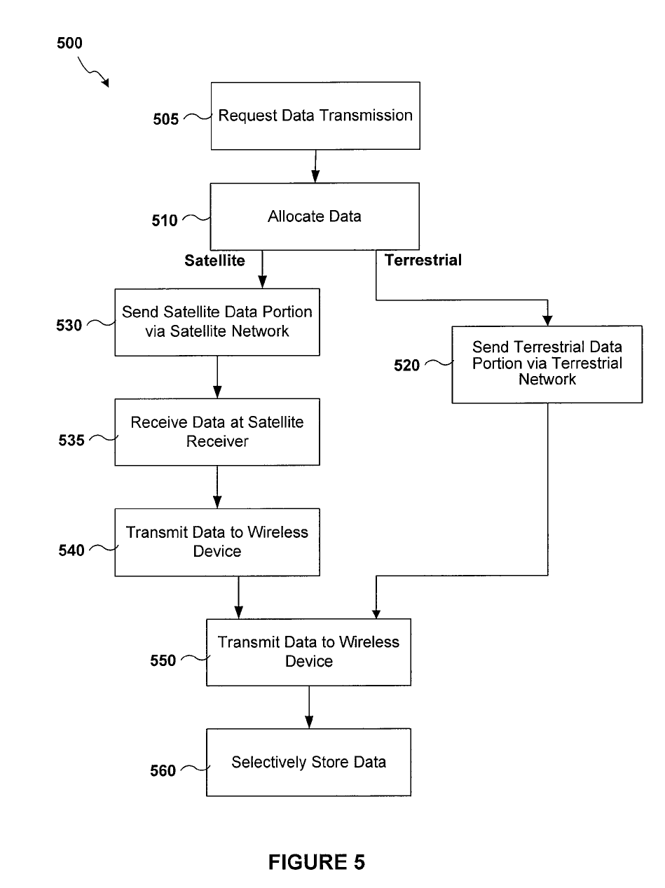

FIG. 5 illustrates an embodiment of a process 500 of the invention for providing and storing digital data at a wireless device in accordance with aspects of the invention. As illustrated in FIG. 5, digital data provision may begin at stage 505 with a request for data transmission provided by a user from the user's wireless device, such as wireless device 105b. The request is typically made via a terrestrial wireless network to a server and/or a control unit such as server 101b and control unit 107 through terrestrial tower 106b. The request may be made via a user input and/or through an automatically generated wireless device request. Alternately, in some embodiments no request may be needed and the digital data may be allocated based on other criteria, such as terrestrial network limitations or unavailability, channel or other limitations, or other criteria. Digital data may then be allocated at stage 510 between a satellite network and a terrestrial network. In some embodiments all or most of the digital data may be provided via the satellite network, however, in other embodiments data may be divided between the networks evenly or weighted towards the terrestrial network. If allocated, the terrestrial data portion may be sent at stage 520 through one or more terrestrial networks to the wireless device. In addition, the satellite data portion may be sent through a satellite network at stage 530, received by a satellite receiver at stage 535, where the satellite receiver is typically in communication with the wireless device and/or integrated within the wireless device. The data may then be transferred to the wireless device from the satellite receiver at stage 540 such as by wired or wireless connection. The wireless device may then receive the portional satellite and/or terrestrial data at stage 550, and the data may be selectively processed and stored on the wireless device at stage 560.

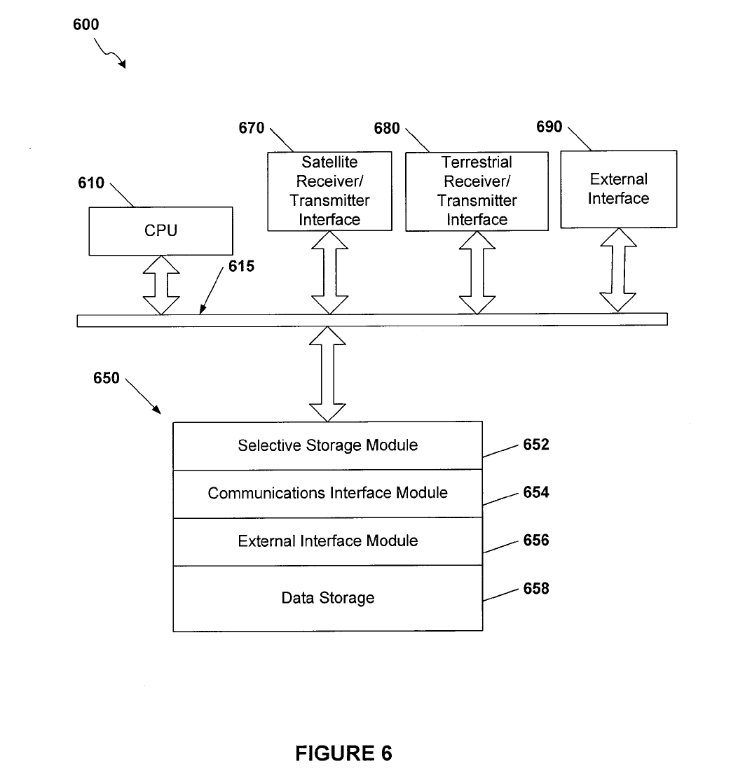

FIG. 6 illustrates one embodiment of a processor system for facilitating implementations of the present invention on a wireless device. As illustrated in FIG. 6, the wireless device may include processor subsystem 600 including a CPU 610, one or more data busses 615, a satellite receiver interface 670, a terrestrial wireless receiver interface 680, one or more optional external interface 690 along with a memory 650 configured to store processor readable instructions and data. Memory 650 may include one or more modules configured to provide functionality related to aspects of the invention as are described herein, including a selective storage module configured to process received data and selectively store the data, in some embodiments based on a user provided selection criteria. Additional modules such as module 654 may be provided to implement and manage interfaces to the satellite and/or terrestrial receivers and or other data interfaces. External interface module 656 may be provided to implement and manage interfaces to other modules of the wireless device and/or to external devices. Data storage module 658 may be provided to store data such as received digital data, selectively stored data or other data or digital information related to wireless device operation.

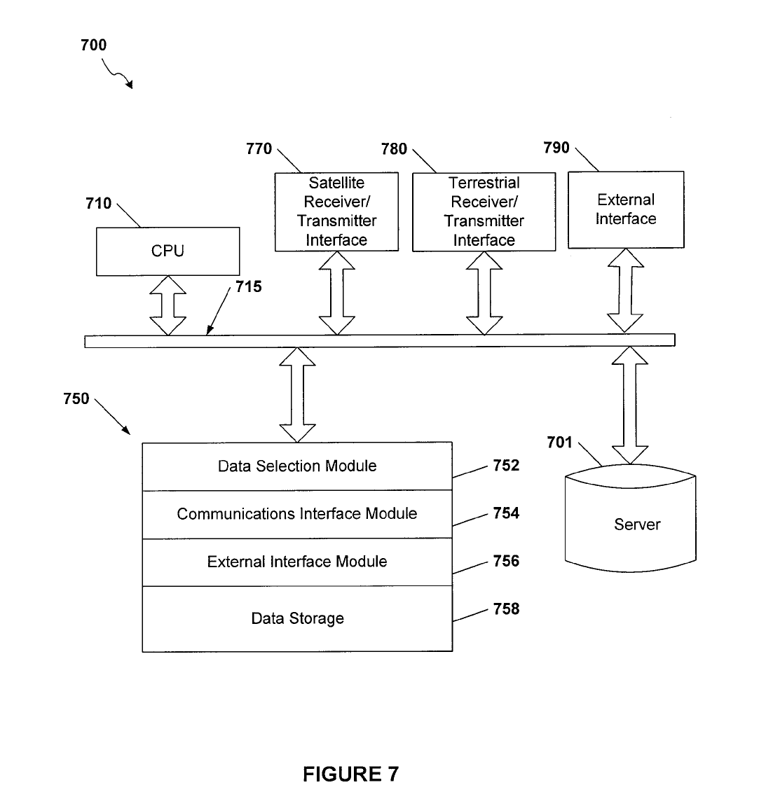

FIG. 7 illustrates one embodiment of a processor system for facilitating implementations of the present invention on a control unit. As illustrated in FIG. 7, the control unit may include processor subsystem 700 including a CPU 710, one or more data busses 715, a satellite receiver interface 770, a terrestrial wireless receiver interface 780, one or more optional external interface 790 along with a memory 750 configured to store processor readable instructions and data. Memory 750 may include one or more modules configured to provide functionality related to aspects of the invention as are described herein, including a data selection module configured to receive a request for data transmission via a satellite network, analyze request criteria and parameters, and manage data allocation between terrestrial and wireless networks as is described elsewhere herein. Additional modules such as module 754 may be provided to implement and manage interfaces to the satellite and/or terrestrial receivers and or other data interfaces. External interface module 756 may be provided to implement and manage interfaces to other modules of the wireless device and/or to external devices, such as one or more data interfaces to a server such as server 701, which may be an implementation of server 101b shown in FIG. 1b. Data storage module 758 may be provided to store data such as digital data to be transmitted, portional data, and/or other data or digital information related to system operation.

In accordance with one aspect the present invention relates to allocation of digital data between a terrestrial wireless network and a satellite network. While specific data allocation approaches are described herein, it will be apparent to those of ordinary skill in the art that data portions to be transmitted via the satellite and terrestrial transmission tower can be allocated between these two transmission means according to allocation strategies other than those described in the examples herein. For example, rather than allocating data portions via satellite only when a convention terrestrial transmission tower cannot meet the data transmission requirements, alternate allocation rules could be applied based on minimizing data transmission cost, maximizing throughput of the wireless communication network or based on other optimization criteria.

It is noted that in various embodiments the present invention may relate to processes such as are described or illustrated herein and/or in the related applications. These processes are typically implemented in one or more modules comprising systems as described herein and/or in the related applications, and such modules may include computer software stored on a computer readable medium including instructions configured to be executed by one or more processors. It is further noted that, while the processes described and illustrated herein and/or in the related applications may include particular stages, it is apparent that other processes including fewer, more or different stages than those described and shown are also within the spirit and scope of the present invention. Accordingly, the processes shown herein and in the related applications are provided for purposes of illustration, not limitation.

As noted, some embodiments of the present invention may include computer software and/or computer hardware/software combinations configured to implement one or more processes or functions associated with the present invention such as those described above and/or in the related applications. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one of ordinary skill in the art that specific details are not required in order to practice the invention. Thus, the foregoing descriptions of specific embodiments of the invention are presented for purposes of illustration and description, not limitation. They are not intended to be exhaustive or to limit the invention to the precise forms disclosed; obviously, many modifications and variations are possible in view of the above teachings. For example, wireless communication devices utilized by the present invention are not limited to cellular telephones, but can be any wireless communication device, such as personal data assistants and laptop computers, amongst others. In addition, the satellites described in the present invention are not limited to geostationary satellites, but could also be lower earth orbital or middle earth orbital satellites. These and other variations and modifications of the embodiments disclosed herein may be made without departing from the spirit and scope of the invention as set forth by the claims.

The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

I claim:

1. A method of receiving digital data at a wireless enabled device, comprising:
receiving, at the wireless device, a first portion of the digital data from a satellite included within a satellite communication network;
storing, at the wireless device, at least part of said first portion of said digital data; and
receiving, at the wireless device, a second portion of the digital data from a terrestrial wireless network.

2. The method of claim 1 further comprising generating and sending, from the wireless device, a request for satellite data transmission via the terrestrial wireless network.

3. The method of claim 2 wherein the request for satellite data transmission is generated automatically by the wireless device.

4. The method of claim 2 wherein the request for satellite data transmission is generated in response to a user input.

5. The method of claim 1 wherein the terrestrial wireless network is a cellular network.

6. The method of claim 1 wherein the terrestrial wireless network is a local area network (LAN).

7. The method of claim 6 wherein the LAN is an 802.11 based LAN.

8. The method of claim 1 further comprising:
selecting, at the wireless device, a portion of the other digital data for storage; and
storing, at the wireless device, said portion of the digital data.

9. The method of claim 8 wherein said portion of the digital data is selected based at least in part on a user supplied selection criteria.

10. The method of claim 1 wherein said selected digital data from said first portion is selected based at least in part on a user supplied selection criteria.

11. A method of providing digital data to a wireless device, comprising:
receiving, at a control unit, a request for transmission of digital data to the wireless device;
allocating, at the control unit, a first portion of the digital data for transmission to the wireless device via a satellite network; and
sending, to a satellite uplink, said first portion of the digital data.

12. The method of claim 11 further comprising sending a second portion of the digital data to the wireless device via a terrestrial wireless network.

13. The method of claim 11 wherein said allocating comprises:
determining if a transmission requirement of the digital data exceeds a capacity of a terrestrial wireless network, wherein the wireless device is configured to operate in the terrestrial wireless network; and
selecting said first portion responsive to said determining.

14. The method of claim 13 wherein the transmission requirement comprises a minimum bandwidth and the capacity comprises a maximum bandwidth.

15. The method of claim 13 wherein the transmission requirement comprises a size of the digital data and the capacity comprises a maximum data size.

16. The method of claim 13 wherein the transmission requirement comprises a set of cost of service parameters and the capacity comprises a maximum cost.

17. The method of claim 13 wherein the transmission requirement comprises a throughput parameter and the capacity comprises a maximum throughput.

18. A computer readable medium, comprising executable instructions to:
facilitate receiving, at the wireless device, a first portion of the digital data provided from a satellite included within a satellite network;
select, at the wireless device, at least part of said first portion for storage;
store, at the wireless device, said selected digital data from said first portion; and
facilitate receiving, at the wireless device, a second portion of the digital data provided via a terrestrial wireless network.

19. The medium of claim 18 further comprising instructions to generate and send, via the terrestrial wireless network, a request for satellite data transmission.

20. The medium of claim 19 wherein the request for satellite data transmission is generated automatically by the wireless device.

21. The medium of claim 19 wherein the request for satellite data transmission is generated in response to a user input.

22. The medium of claim 19 wherein the terrestrial wireless network is a cellular network.

23. The medium of claim 19 wherein the terrestrial wireless network is a local area network (LAN).

24. The medium of claim 23 wherein the LAN is an 802.11 based LAN.

25. The method of claim 19 further comprising instructions to:
select, at the wireless device, at least part of said second portion for storage; and
store, at the wireless device, said selected part of said second portion.

26. The medium of claim 25 wherein said selected part of said first portion and said selected part of said second portion are chosen based at least in part on a user supplied selection criteria.

27. The medium of claim 19 wherein said selected part of said first portion is selected based at least in part on a user supplied selection criteria.

28. A computer readable medium, comprising executable instructions to:
facilitate receiving, at a control unit, a request for transmission of digital data to a wireless device, said request provided via a terrestrial wireless network;
allocate, at the control unit, a first portion of the digital data for transmission to the wireless device via a satellite network; and
send, to a satellite uplink, from the server, said first portion of the digital data.

29. The medium of claim 28 wherein the instructions for allocating comprise instructions to:
determine if a transmission requirement of the digital data exceeds a capacity of a terrestrial wireless network, wherein the wireless device is configured to operate in the terrestrial wireless network; and
select said first portion responsive to said determining.

30. The medium of claim 29 wherein the transmission requirement comprises a minimum bandwidth and the capacity comprises a maximum bandwidth.

31. The medium of claim 29 wherein the transmission requirement comprises a size of the digital data and the capacity comprises a maximum data size.

32. The medium of claim 29 wherein the transmission requirement comprises a set of cost of service parameters and the capacity comprises a maximum cost.

33. The medium of claim 29 wherein the transmission requirement comprises a throughput parameter and the capacity comprises a maximum throughput.
